(19) United States
(12) Patent Application Publication
(10) Pub. No.: US 2025/0102851 A1
(43) Pub. Date: Mar. 27, 2025

(54) DISPLAY SCREEN

(71) Applicant: HUIZHOU TCL MOBILE COMMUNICATION CO., LTD., Huizhou, Guangdong (CN)

(72) Inventors: Jitao MA, Huizhou, Guangdong (CN); Zhuwei QIU, Huizhou, Guangdong (CN); Ke LIN, Huizhou, Guangdong (CN); Yang YU, Huizhou, Guangdong (CN); Yafang XI, Huizhou, Guangdong (CN)

(73) Assignee: HUIZHOU TCL MOBILE COMMUNICATION CO., LTD., Huizhou, Guangdong (CN)

(21) Appl. No.: 18/707,585

(22) PCT Filed: Jan. 3, 2023
(86) PCT No.: PCT/CN2023/070043

§ 371 Date: Dec. 9, 2024

(30) Foreign Application Priority Data
Jan. 21, 2022 (CN) 202220179262.9

(51) Int. Cl. G02F 1/1335; G02F 1/13357

(52) U.S. Cl. CPC G02F 1/133502; G02F 1/133514; G02F 1/133528; G02F 1/133606

(57) ABSTRACT

A display screen (10). The display screen (10) comprises a display panel (100) and an optical layer group (200), which is arranged on a light-emitting side of the display panel (100), wherein the optical layer group (200) is arranged on the light-emitting side of the display panel (100), the optical layer group (200) at least comprises an anti-glare layer, an anti-blue-light layer and an anti-reflection layer, which are arranged in a stacked manner, and the anti-glare layer can selectively perform mirror surface reflection or diffuse reflection on light that is incident to the display screen (10). By means of the display screen (10), the problems of glare, eye fatigue and vision damage caused by blue light of the high-brightness display screen (10) can be solved.

This application claims the priority of Chinese Patent Application No. 202220179262.9, entitled “DISPLAY SCREEN”, filed on Jan. 21, 2022 in the China National Intellectual Property Administration (CNIPA), the content of which is incorporated herein by reference in its entirety.

### TECHNICAL FIELD

The present disclosure relates to a display technology field, and more particularly to a display screen.

### BACKGROUND ART

Conventional mobile phones, tablets, and monitors blindly pursue display brightness. High brightness of display screens is prone to glare problems. At the same time, high-brightness displays can also cause eye fatigue for viewers, and blue light can damage vision. This results in a poor experience for end consumers.

Therefore, there is an urgent need to provide a display screen to solve the above-mentioned technical problems.

### SUMMARY OF DISCLOSURE

### Technical Problem

In order to solve the above technical problems, the present disclosure provides a display screen capable of solving problems existing in high brightness displays such as glare, easy eye fatigue, and blue light damaging vision.

### Solution of Problem

### Technical Solution

A display screen, the display screen including:
a display panel; and
an optical layer group, the optical layer group disposed on a light emitting side of the display panel and at least including an anti-glare layer, an anti-blue light layer, and an anti-reflection layer;
wherein the anti-glare layer is configured to selectively reflect specularly or diffusely light incident on the display screen.

In the display screen provided by the present disclosure, the anti-glare layer has a first surface away from the display panel, and the first surface is a rough surface; and
a surface roughness of the first surface changes based on a change in a light intensity or an electric field, so that a light reflection state of the anti-glare layer changes.

In the display screen provided by the present disclosure, the first surface is formed with a plurality of photomicrostructures or electromicrostructures.

In the display screen provided by the present disclosure, the anti-glare layer is formed by the electromicrostructures, side surface electrodes are provided on an outer periphery of the anti-glare layer, and a control electric field is generated through the side surface electrodes.

In the display screen provided by the present disclosure, the anti-glare layer is obtained by forming the photomicrostructures or the electromicrostructures on a surface of a substrate or a base layer through photolithography, composite processing, or vacuum sputtering.

In the display screen provided by the present disclosure, the display screen further includes a cover plate, and the anti-glare layer is configured by the cover plate.

In the display screen provided by the present disclosure, the display screen further includes a touch layer, and one insulation layer in the touch layer is set as the anti-glare layer.

In the display screen provided by the present disclosure, the display screen further includes a touch layer, and multiple insulation layers in the touch layer are set as the anti-glare layer.

In the display screen provided by the present disclosure, wherein an adhesive layer is provided between the display panel and the touch layer for bonding the display panel and the touch layer, and a material of the adhesive layer includes optical glue and diffusion particles.

In the display screen provided by the present disclosure, the display panel includes an array substrate and a color filter substrate arranged in pairs, and a base substrate of the color filter substrate is configured as the anti-glare layer.

In the display screen provided by the present disclosure, the anti-glare layer is a layer of a haze-adjustable liquid crystal cell.

In the display screen provided by the present disclosure, in a specular reflection state, haze of the anti-glare layer ranges from 8% to 25%, and a surface roughness of the anti-glare layer is less than or equal to 0.02 um; and
in a diffuse reflection state, haze of the anti-glare layer range less than 1%, and a surface roughness of the anti-glare layer ranges from 0.34 um to 0.36 um.

In the display screen provided by the present disclosure, in a specular reflection state, a light transmittance of the anti-glare layer is greater than or equal to 92%, and in a diffuse reflection state, a light transmittance of the anti-glare layer is greater than or equal to 75%.

In the display screen provided by the present disclosure, the display screen includes a backlight module disposed on a light incident side of the display panel, and the backlight module includes:
a white light backlight source, the white light backlight source for providing backlight for the display panel; and
a diffusion layer, the diffusion layer located between the display panel and the white light source.

In the display screen provided by the present disclosure, the diffusion layer includes a plurality of stacked sub-layers, a transmittance of each of the sub-layers is 80% to 100%, and haze of each of the sub-layers ranges from 90% to 100%.

In the display screen provided by the present disclosure, the display screen further includes an upper polarizer and/or a lower polarizer, the upper polarizer is disposed on the light emitting side of the display panel, and the lower polarizer is disposed on a light incident side of the display panel; and
a surface of the upper polarizer and/or a surface of the lower polarizer is a rough surface.

### Advantageous Effects of Disclosure

### Advantageous Effects

Beneficial effects of the present disclosure are described as follows. Compared with the prior art, in the display screen and display device described in the present disclosure, the optical layer group having the anti-blue light layer, the anti-reflective layer, and the anti-glare layer is provided on the light emitting side of the display screen. The anti-glare layer is configured to selectively perform diffuse reflection or specular reflection of ambient light incident on its surface, which can solve problems existing in high brightness displays such as glare, easy eye fatigue, and blue light damaging vision.

### BRIEF DESCRIPTION OF DRAWINGS

### Description of Drawings

The technical solutions and other beneficial effects of the present disclosure will be apparent through a detailed description of the specific embodiments of the present disclosure in conjunction with the accompanying drawings.

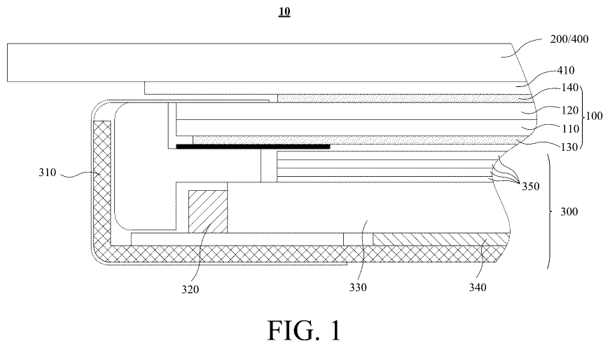

FIG. 1 illustrates a cross-sectional view of a display screen provided by an embodiment of the present disclosure.

### DISCLOSED EMBODIMENTS

### Embodiments of Present Disclosure

The technical solutions in the embodiments of the present disclosure will be clearly and completely described below with reference to the accompanying drawings in the embodiments of the present disclosure. Apparently, the described embodiments are only some of the embodiments of the present disclosure, not all of them. Based on the embodiments in the present disclosure, all other embodiments obtained by those skilled in the art without creative efforts fall within the scope of protection of the present disclosure.

In the drawings, the shapes and dimensions can be exaggerated for clarity, and the same reference numbers will be used throughout the drawings to refer to the same or similar parts.

Unless otherwise defined, technical or scientific terms used herein shall have their ordinary meaning as understood by those skilled in the art to which the present disclosure belongs. “First”, “second” and similar words used in the specification and claims of the present disclosure do not indicate any order, quantity or importance, but are only used to distinguish different components. Likewise, similar words such as “a”, “an” or “the” do not indicate a quantitative limitation but rather indicate the presence of at least one. The words “including” or “include” and similar words mean that the elements or things that appear before “including” or “include” cover the elements or things that appear after “including” or “include”. Their equivalents do not exclude other elements or objects. “Up”, “down”, “left”, “right”, etc. are only used to express relative positional relationships. When the absolute position of the described object changes, the relative positional relationship may also change accordingly.

In the following description, terms such as center, thickness, height, length, front, back, rear, left, right, top, bottom, upper, lower, etc. are defined with respect to the configuration shown in the respective figures. In particular, “height” corresponds to the dimension from top to bottom, “width” corresponds to the dimension from left to right, and “depth” corresponds to the dimension from front to back. They are relative concepts, so they may change accordingly according to their different locations and different uses. Therefore, these or other terms should not be construed as limiting terms.

Terms referring to attachment, coupling, and the like (e.g., “connected” and “attached”) refer to the relationship in which structures are directly or indirectly secured or attached to each other through intervening structures. Movable, rigid attachment, or relationship is described, unless otherwise expressly stated.

Please refer to FIG. 1. The present disclosure provides a display screen 10. The display screen 10 includes a display panel 100, an optical layer group 200 disposed on a light emitting side of the display panel 100, and a backlight module 300 disposed on a light incident side of the display panel 100. The backlight module 300 is used for providing backlight for the display panel 100. The display panel 100 is used for a display image. The optical layer group 200 is used for adjust light emission effect of the display panel 100.

In the present embodiment, the display panel 100 can be an LCD (Liquid Crystal Display). The display panel 100 includes an array substrate 110 and a color filter substrate 120 arranged in pairs and a liquid crystal layer sealed between the array substrate 110 and the opposite substrate. A pixel electrode and a common electrode are provided on opposite inner sides of the array substrate 110 and the color filter substrate 120. The liquid crystal display panel 100 uses an electric field to control an orientation of liquid crystal molecules and change a polarization state of light.

It should be noted that FIG. 1 only schematically illustrates a structure of the display panel 100 and does not illustrate a specific film layer structures of the array substrate 110 and the color filter substrate 120 in detail.

Please refer to FIG. 1. The optical layer group 200 described in the present disclosure at least includes an anti-blue light layer, an anti-reflection (AR) layer, and an anti-glare (AG) layer.

The anti-glare layer can selectively reflect specularly or diffusely light incident on the display screen 10. In a specular reflection state, haze of the anti-glare layer ranges from 8% to 25%, and a surface roughness of the anti-glare layer is less than or equal to 0.02 um. In a diffuse reflection state, haze of the anti-glare layer range less than 1%, and a surface roughness of the anti-glare layer ranges from 0.34 um to 0.36 um.

More specifically, in the specular reflection state, a light transmittance of the anti-glare layer is greater than or equal to 92%. In the diffuse reflection state, a light transmittance of the anti-glare layer is greater than or equal to 75%.

The present embodiment provides two implementations of the anti-glare layer. The implementations of the anti-glare layer will be described in detail below with reference to the structure of the display screen 10.

In a first implementation, the anti-glare layer has a first surface away from the display panel 100, and the first surface is a rough surface. A surface roughness of the first surface changes based on a change in a light intensity or an electric field it feels, so that a light reflection state of the anti-glare layer changes.

Specifically, the first surface is formed with a plurality of photomicrostructures or electromicrostructures. The photomicrostructures or the electromicrostructures refers to whether microstructures are formed on the first surface, which is affected by the light intensity or the electric field felt by the first surface.

In specific use, when the first surface is formed with the photomicrostructures or electromicrostructures, the surface roughness of the first surface is relatively large. The anti-glare layer can diffusely reflect ambient light incident on the display screen 10 to make it more comfortable for human eyes to see.

In order to control the change in the light reflection state of the anti-glare layer, the photomicrostructures can be configured. When the ambient light intensity exceeds a preset upper limit, the microstructures are formed on the first surface. When the ambient light intensity is less than or equal to the preset upper limit, the microstructures are not formed on the first surface. As such, the anti-glare layer can automatically switch its own reflective state according to the ambient light intensity it senses.

As for the anti-glare layer formed by the electromicrostructures, side surface electrodes (or side electrodes) can be provided on an outer periphery of the anti-glare layer, and a control electric field is generated through the side surface electrodes. For example, when a photosensitive device of the entire display screen 10 senses a change in the light intensity or the brightness, light intensity change information or brightness change information can be transmitted to a CPU of the display screen 10. The CPU can refer to a preset program to determine whether it is necessary to energize the side electrodes.

The anti-glare layer using the electromicrostructures can achieve more precise control of the reflective state of the anti-glare layer. Moreover, since the side electrodes are arranged on the side, display effect of a display area is not be affected.

In a specific implementation, the anti-glare layer can be obtained by forming the photomicrostructures or the electromicrostructures on a surface of a substrate or a base layer through photolithography, composite processing, or vacuum sputtering.

In the present embodiment, the anti-glare layer can be conveniently integrated on a functional film layer of the display screen 10 itself. As such, the effect can be achieved without increasing a thickness.

Please refer to FIG. 1. In the present embodiment, the display screen 10 is a touch display screen. The display screen 10 includes a touch layer 400. The touch layer 400 is located on the light emitting side of the display panel 100. At this time, one or more insulation layers in the touch layer 400 can be set as the anti-glare layer.

During a specific implementation, an adhesive layer 410 is provided between the display panel 100 and the touch layer 400 for bonding the display panel 100 and the touch layer 400. A material of the adhesive layer 410 includes optical glue and diffusion particles.

In other embodiments, the display screen 10 further includes a cover plate. The cover plate is located on the light emitting side of the display panel 100. At this time, the cover plate can be configured as the anti-glare layer. Preferably, a surface of the light emitting side of the cover plate is configured as the rough surface.

In some embodiments, the light emitting side surface of the display panel 100 can be directly configured as a rough surface to directly integrate the anti-glare layer into the display panel 100. Commonly, a base substrate of the color filter substrate 120 can be configured as the anti-glare layer.

In a second implementation, the anti-glare layer is a layer of a haze-adjustable liquid crystal cell.

Preferably, the haze-adjustable liquid crystal cell includes two opposite substrates and a liquid crystal layer sealed between the two substrates. Electrodes are provided on opposite inner sides of the two substrates (i.e., a side facing the liquid crystal layer). By applying voltages of different strengths to the electrodes in the liquid crystal cell, deflection angles of liquid crystal molecules of the liquid crystal cell are changed. The haze of the haze-adjustable liquid crystal cell is adjusted, thereby changing a reflection of ambient light by the liquid crystal cell.

For example, when a voltage intensity applied to the electrodes is greater, an effective refractive index of the liquid crystal molecules in the liquid crystal cell basically matches a refractive index of a polymer. When a transparency of the liquid crystal cell becomes greater, the haze of the liquid crystal cell becomes smaller. When the voltage intensity applied to the electrodes is smaller, a difference between the effective refractive index of the liquid crystal molecules and the refractive index of the polymer is greater. When the transparency of the liquid crystal cell is smaller, the haze of the liquid crystal cell is greater.

When external light is weak in use, the voltage intensity applied to the electrodes in the haze-adjustable liquid crystal cell is greater. When the external light is stronger, the voltage intensity applied to the two planar electrodes in a PDLC liquid crystal cell is smaller.

The liquid crystal layer can be the PDLC liquid crystal layer. A thickness of the PDLC liquid crystal layer is not greater than 10 um. The substrate is a polyimide film. The electrodes are made of an ITO film. A spacer is formed by the frame glue.

The haze-adjustable liquid crystal cell can adjust the haze according to changes in ambient light intensity to achieve effective and moderate anti-glare and anti-reflection to improve the display effect. Furthermore, the substrate of the haze-adjustable liquid crystal cell is a transparent flexible film made of non-glass material. Compared with a glass substrate, it can minimize the reflection effect caused by the outer surface of the liquid crystal cell itself, thereby further ensuring the anti-glare and anti-reflective effect.

In the present embodiment, the present disclosure does not make any specific limitations on the specific film layer position of the haze-adjustable liquid crystal cell. For example, the haze-adjustable liquid crystal cell can be disposed on the cover plate or can be attached to the surface of the light emitting side of the display panel 100 in a direct contact manner.

Specifically, the anti-blue light layer can be directly disposed on the anti-glare layer or on the layer where the anti-glare layer is located.

The anti-blue light layer can block high-intensity blue light emitted by the display screen 10, so that the blue light entering human eyes has a compound eye-protecting effect. In the present embodiment, the anti-blue light layer can be directly formed on the anti-glare layer in the form of a coating. However, it should be pointed out that a specific implementation form of the anti-blue light layer described in the present disclosure is not limited thereto.

Specifically, the anti-reflective layer can be directly integrated on the anti-glare layer or on the layer where the anti-glare layer is located.

The anti-reflective layer can reduce a reflectivity of the display screen 10 and increase a transmittance of the display screen 10. In the present embodiment, the anti-reflective layer includes a high refractive index layer and a low refractive index surface layer disposed on the high refractive index layer. In a specific implementation, high and low refractive index materials can be cross-stacked and evaporated through vacuum evaporation or magnetron sputtering plating. However, the present disclosure does not essentially limit the specific structure and implementation of the anti-reflection layer. For example, in other embodiments, the anti-reflective layer can be formed by making reflective microstructures (e.g., one-dimensional grating or two-dimensional grating) on a surface of a transparent substrate or a transparent board.

Preferably, multiple optical layers of the optical layer group 200 are stacked into a composite structural layer. At this time, the optical layer group 200 is arranged as a whole. Commonly, the anti-blue light layer and/or the anti-reflective layer can be arranged on the anti-glare layer in the form of a material coating. However, it should be noted that the present disclosure does not limit the stacking order of the anti-blue light layer, the anti-reflection layer and the anti-glare layer.

This arrangement has a high degree of integration and can prevent the thickness of the optical layer group 200 from adversely affecting the display effect and light emission effect. At this time, the specific position of the composite structure layer is not subject to any specific limitation. It can be disposed directly on the display panel 100 or on the touch layer 400.

Preferably, the anti-blue light layer, the anti-reflective layer, and the anti-glare layer can be integrated on the touch layer 400. At this time, the optical layer group 200 can be configured on the touch layer 400.

Preferably, the anti-blue light layer, anti-reflection layer, and anti-glare layer can be integrated on the cover plate. More specifically, the cover plate can be configured as the anti-glare layer, and the anti-blue light layer and the anti-reflective layer are stacked on one side or both sides of the cover plate.

Alternatively, when the base substrate of the color filter substrate 120 is configured as the anti-glare layer, the anti-blue light layer and the anti-reflection layer can be directly integrated on the base substrate of the color filter substrate 120.

The arrangement of the optical layer group 200 of the present disclosure is not limited thereto. For example, in some embodiments, multiple optical layers in the optical layer group 200 can be respectively configured on different functional layers of the display screen 10.

Please refer to FIG. 1. The display screen 10 further includes an upper polarizer 140 and/or a lower polarizer 130. By polarizing effect of the upper polarizer 140 and/or the lower polarizer 130, display brightness of the display screen 10 can be controlled.

During a specific implementation, the upper polarizer 140 can be disposed on the light emitting side of the display panel 100. The lower polarizer 130 can be disposed on the light incident side of the display panel 100. By the polarizing effect of the upper polarizer and/or the lower polarizer, the display brightness of the display screen 10 can be controlled.

Preferably, a surface of the upper polarizer and/or a surface of the lower polarizer is a rough surface, so that the upper polarizer and/or the lower polarizer has an anti-glare function. By changing a roughness and/or a roughness of the polarizers, the surface and/or the surface of the polarizers has a matte effect and achieves diffuse reflection.

In a specific implementation, chemical etching or spraying can be used for obtaining a rough surface.

Please refer to FIG. 1. The backlight module 300 includes a backplane 310, a white light backlight source 320, a light guide plate 330, a reflective layer 340, and a diffusion layer 350. By a white light source, amount of blue light emitted can be reduced. This is beneficial for achieving anti-blue light effect.

Please refer to FIG. 1. The back plate 310 is used for carrying the entire backlight module 300. The white light backlight source 320 and the light guide plate 330 are both disposed on one side of the back plate 310 facing the display panel 100. The white light backlight source 320 is placed on one side of the light guide plate 330. Light from the white light backlight 320 enters the light guide plate 330 through the side of the light guide plate 330 and then exits through an upper surface of the light guide plate 330. The light guide plate 330 converts a line light source emitted by the white light backlight source 320 into a surface light source.

Please refer to FIG. 1. The reflective layer 340 is located between the back plate 310 and the light guide plate 330 and is used for reflecting light emitted from a bottom surface of the light guide plate 330 to a visible area for reuse.

The light guide plate 330 is made of material which can be used for a light guide plate or a light guide layer. For example, the light guide plate 330 is made of polymethylmethacrylate (PMMA), polycarbonate (PC), polyethylene (PE), polypropylene (PP), polyethylene terephthalate (PET), or polyimide (PI).

Specifically, the reflective layer 340 can adopt a single-layer structure or a multi-layer stacked structure. A film layer used for forming the reflective layer 340 can be at least one of a reflective film or a metal reflective layer. The metal reflective layer can be metal with a reflective function or a light reflective function. The metal with the reflective function or the reflective function can be, but is not limited to, aluminum (Al) or silver (Ag). The metal reflective layer can be formed by deposition using a PVD process. The reflective layer 340 can be a reflective film which can be directly attached.

Please refer to FIG. 1. The diffusion layer 350 is disposed on one side of the light guide plate 330 facing the display panel 100, and the diffusion layer 350 includes a plurality of stacked sub-layers. A transmittance of each of the sub-layers is 80% to 100%, and haze of each of the sub-layers ranges from 90% to 100%.

The present disclosure does not specifically limit the specific structure, the form, or the material of the diffusion layer 350. As long as an actual configuration of the diffusion layer 350 is reasonable, it can achieve effect of diffusing the incident. light.

In other embodiments, the backlight module 300 can further include other optical functional layers, for example, but not limited to a fluorescent layer or a polarizing layer.

At the same time, it should be noted that the present disclosure does not limit the specific structure of the backlight module 300. That is, those skilled in the art can make experimental settings or improve the design of the backlight module 300 according to actual design requirements based on the teachings of the present disclosure, which are common technical means in the field and not be described in detail here.

In the display screen of the present disclosure, the optical layer group 200 having the anti-blue light layer, the anti-reflective layer, and the anti-glare layer is provided on the light emitting side of the display screen. The anti-glare layer is configured to selectively perform diffuse reflection or specular reflection of ambient light incident on its surface, which can solve problems existing in high brightness displays such as glare, easy eye fatigue, and blue light damaging vision. Improve end-user experience. End-user experience can be improved.

The present disclosure is further explained in detail by the following non-limiting examples.

Equipment quantities and processing scales described herein are intended to simplify the description of the present disclosure. Applications, modifications, and variations of the present disclosure are apparent to those skilled in the art.

Components of various embodiments described herein can be combined to form other embodiments not specifically stated above. Parts can be omitted from structures described herein without adversely affecting their operation. Furthermore, various individual components can be combined into one or more individual components to perform the functions described herein.

Furthermore, although the embodiments of the present disclosure are disclosed above, they are not limited to applications listed in the description and embodiments. It can be fully applied to various fields suitable for the present disclosure. For those familiar with the art, other modifications can be easily implemented. Therefore, the present disclosure is not limited to specific details and illustrations shown and described herein without departing from the general concept defined by the claims and their equivalent scope.

What is claimed is:

1. A display screen, the display screen comprising:
a display panel; and
an optical layer group, the optical layer group disposed on a light emitting side of the display panel and at least comprising an anti-glare layer, an anti-blue light layer, and an anti-reflection layer;
wherein the anti-glare layer is configured to selectively reflect specularly or diffusely light incident on the display screen.

2. The display screen of claim 1, wherein the anti-glare layer has a first surface away from the display panel, and the first surface is a rough surface; and
a surface roughness of the first surface changes based on a change in a light intensity or an electric field, so that a light reflection state of the anti-glare layer changes.

3. The display screen of claim 2, wherein the first surface is formed with a plurality of photomicrostructures or electromicrostructures.

4. The display screen of claim 3, wherein the anti-glare layer is formed by the electromicrostructures, side surface electrodes are provided on an outer periphery of the anti-glare layer, and a control electric field is generated through the side surface electrodes.

5. The display screen of claim 3, wherein the anti-glare layer is obtained by forming the photomicrostructures or the electromicrostructures on a surface of a substrate or a base layer through photolithography, composite processing, or vacuum sputtering.

6. The display screen of claim 2, wherein the display screen further comprises a cover plate, and the anti-glare layer is configured by the cover plate.

7. The display screen of claim 2, wherein the display screen further comprises a touch layer, and one insulation layer in the touch layer is set as the anti-glare layer.

8. The display screen of claim 2, wherein the display screen further comprises a touch layer, and multiple insulation layers in the touch layer are set as the anti-glare layer.

9. The display screen of claim 7 or 8, wherein an adhesive layer is provided between the display panel and the touch layer for bonding the display panel and the touch layer, and a material of the adhesive layer comprises optical glue and diffusion particles.

10. The display screen of claim 2, wherein the display panel comprises an array substrate and a color filter substrate arranged in pairs, and a base substrate of the color filter substrate is configured as the anti-glare layer.

11. The display screen of claim 1, wherein the anti-glare layer is a layer of a haze-adjustable liquid crystal cell.

12. The display screen of claim 1, wherein in a specular reflection state, haze of the anti-glare layer ranges from 8% to 25%, and a surface roughness of the anti-glare layer is less than or equal to 0.02 um; and
in a diffuse reflection state, haze of the anti-glare layer range less than 1%, and a surface roughness of the anti-glare layer ranges from 0.34 um to 0.36 um.

13. The display screen of claim 1, wherein in a specular reflection state, a light transmittance of the anti-glare layer is greater than or equal to 92%, and in a diffuse reflection state, a light transmittance of the anti-glare layer is greater than or equal to 75%.

14. The display screen of claim 1, wherein the display screen comprises a backlight module disposed on a light incident side of the display panel, and the backlight module comprises:
a white light backlight source, the white light backlight source for providing backlight for the display panel; and
a diffusion layer, the diffusion layer located between the display panel and the white light source.

15. The display screen of claim 14, wherein the diffusion layer comprises a plurality of stacked sub-layers, a transmittance of each of the sub-layers is 80% to 100%, and haze of each of the sub-layers ranges from 90% to 100%.

16. The display screen of claim 1, wherein the display screen further comprises an upper polarizer and/or a lower polarizer, the upper polarizer is disposed on the light emitting side of the display panel, and the lower polarizer is disposed on a light incident side of the display panel; and
a surface of the upper polarizer and/or a surface of the lower polarizer is a rough surface.
